(19) United States
(12) Patent Application Publication
(10) Pub. No.: US 2008/0152913 A1
(43) Pub. Date: Jun. 26, 2008

(54) METHOD OF MAKING COMPOSITIONS INCLUDING PARTICLES

(75) Inventors: Madeline P. Shinbach, St. Paul, MN (US); Jimmie R. Baran, Prescott, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/615,507

(22) Filed: Dec. 22, 2006

(51) Int. Cl. B32B 5/16

(52) U.S. Cl. 428/405; 428/403; 428/407

(57) ABSTRACT

Method of making compositions comprising a plurality of particles having improved dispersibility, floodability, flowability, fluidization, packing factor, and/or tap density and/or decrease bulk volume and/or entrained gas of the plurality of particles relative to the plurality of particles free of nanoparticles.

### BACKGROUND

The handling, mixing and delivery of particles can be challenging. Often, one or more physical properties of the particles themselves are important to the particular application. Particulate shape, particulate size and particulate porosity. For example, often describe important physical properties or characteristics. Environmental conditions (humidity, temperature, shear forces among others) encountered by particles during use or storage can, and often do, affect one or more of the particles properties. Aggregation, agglomeration, attrition and flocculation represent some of the more common degradative effects on particles and their presence or progression greatly limits the utility of particles.

Achieving a uniform blend of particles is a problem faced daily by engineers and operators in industries as varied as pharmaceuticals, foods, plastics, ceramics processing, paints, coatings, inks and battery production. Even when an acceptable blend is obtained, additional challenges arise in maintaining the blend through one or more pieces of downstream equipment. Poor blending or the inability to maintain an adequate blend before and during processing can lead to additional and unnecessary costs, including costs associated with rejected material and decreased yields, added blending time and energy, decreased productivities, start-up delays and defective or out-of-specification products. Powder caking of raw and in-process materials, particularly during storage (in, e.g., bags or drums) can also pose significant problems. Both powder caking and an inability to achieve uniform blends and mixtures can decrease batch uniformity which, among other drawbacks, can require increased testing and sampling.

Some flowability aids are known. For example, fumed silica is a common powder additive that can be used to improve flow characteristics. While relatively inexpensive, fumed silica often is ineffective in preventing agglomeration of many particle types. Flowability is also a matter of degree; many, if not most, uses of fumed silica lead to some agglomeration and aggregation. Some undemanding industrial applications can tolerate a level of agglomeration not tolerated in more demanding applications. Applications involving precise metering or mixing of a powder, however, require more. Even in relatively undemanding applications, the ability to improve powder flow can provide an increase in homogeneity with milder mixing conditions or with reduced mixing periods. Additionally, increased powder flowabilities can allow utilization of lower levels of expensive ingredients (e.g., dyes and pigments), particularly where the requirement of using a level of such ingredients correlates with the dispersibility of the materials in the powder with which they are mixed.

Particle handling and processing technologies today lie significantly behind the development pace of companion technologies used in liquid processes, and there remain a great many practical problems handling powders that current methods cannot effectively address. Particles exhibiting enhanced flowability and processability are desired for a wide range of applications including demanding industrial uses. Hence, the use of the present invention may be in any of a variety of manufacturing processing and/or packaging for areas such as pharmaceuticals, foods, plastics, ceramics, paints, coatings, inks.

### SUMMARY

In one aspect, the present invention provides a method of making a composition comprising a plurality of particles (e.g., ceramic (i.e., glass, crystalline ceramic, glass-ceramic, and combinations thereof) and polymeric particles) and nanoparticles, the method comprising:
providing a first composition comprising a first plurality of particles and nanoparticles, wherein the nanoparticles are present in the first composition in an amount more than sufficient to at least one of (a) improve at least one of the dispersibility, floodability, flowability, fluidization, packing factor, or tap density of the first plurality of particles relative to the first composition free of nanoparticles or (b) decrease at least one of the bulk volume or entrained gas collectively of the first composition relative to the collective first pluralities of particles free of nanoparticles; and
adding a second plurality of particles to the first composition to provide a second composition, wherein the nanoparticles are present in the second composition in an amount that is at least sufficient to at least one of (a) improve at least one of the dispersibility, floodability, flowability, fluidization, packing factor, or tap density collectively of the first and second pluralities of particles relative to the second composition free of nanoparticles or (b) decrease at least one of the bulk volume or entrained gas of the second composition relative to the second composition of particles free of nanoparticles (wherein the flowability is the sum of the indices determined by Tests A, F, G (or H, as applicable), and I (and the Carr Indices Charts of Flowability and Floodability); floodability is the sum of the indices determined by the flowability and Tests B, C, and J (and the Carr Indices Charts of Flowability and Floodability), bulk volume (see Test D), dispersibility (see Test J), entrained gas (see Test F), and tap density (see Test E) are determined as described under the Heading “Test Method for Bulk Solids Characterization by Carr Indices; ASTM D6393-99”; Fluidization is determined as described in Example 3; and the Packing factor is determined as described in Example 3 (below in the Examples Section)).

In some embodiments of the invention, dispersibility is improved by at least 2, 3, 4, 5, 6, 7, 8, 9, or even at least 10 percent. In some embodiments of the invention, the floodability is improved by at least 2, 3, 4, 5, 6, 7, 8, 9, or even at least 10 percent. In some embodiments of the invention, the flowability is improved by at least 1, 2, 3, 4, 5, 6, 7, 8, 9, or even at least 10 percent. In some embodiments of the invention, the fluidization is improved by at least 1, 2, 3, 4, 5, 6, 7, 8, 9, or even at least 10 percent. In some embodiments of the invention, the packing factor is improved by at least 0.5, 1, 2, 3, 4, or even at least 5 percent. In some embodiments of the invention, the tap density is improved by at least 1, 2, 3, 4, 5, 6, 7, 8 9, or even at least 10 percent.

Optionally, the method according to the present invention includes incorporating at least one additional (e.g., a third, fourth, a fifth, etc.) plurality of particles into the composition.

In some embodiments, the particles of the first and second pluralities of particles are the same (e.g., in terms of size, shape, composition, microstructure, surface characteristics, etc.), while in other embodiments they are different. In some embodiments, the particles of the first and second pluralities of particles are the same (e.g., in terms of size, shape, composition, microstructure, surface characteristics, etc.), while in other embodiments they are different. In some embodiments, the particles of the first and second plurality of particles are the same, while in other embodiments they are different. In some embodiments, the particles of the first plurality of particles have a bi-modal or tri-modal distribution. In some embodiments, the particles of the second plurality of particles have a bi-modal or tri-modal distribution. In some embodiments, the particles of the first and second plurality of particles have a bi-modal distribution with respect to each other.

The handling of materials in a solid particulate form presents many challenges in end uses. Some examples of these challenges include minimizing dust and accurate quantitative measurement of materials into a variety of chemical and physical processes. The challenge becomes amplified when the particles are small. By having masterbatches, as done in accordance with the present invention, that are previously prepared, and by adding these masterbatches at the point of use, certain handling considerations are improved, or in some instances, may be eliminated. Examples of applications where handling considerations are important include extrusion, preparation of medicaments and transfer of solids in manufacturing processes.

### DETAILED DESCRIPTION

Any of a variety of nanoparticles and particles (i.e., the first, second, etc. plurality of particles) can be used to practice the present invention.

In an exemplary embodiment, the nanoparticles are individual, unassociated (i.e., non-aggregated) particles that are mixed with, blended with or are otherwise distributed within the plurality of particles. In some exemplary embodiments, the nanoparticles will not irreversibly associate with one another. The term “associate with” or “associating with” includes, for example, covalent bonding, hydrogen bonding, electrostatic attraction, London forces, and hydrophobic interactions. While not subject to any specific physical characterization and not intending to be limited to any single characterization, one non-limiting way to identify the plurality of particles is when it is composed principally of relatively small individual particles or relatively small groups of individual particles.

Generally, such particles will have an average size (generally measured as an effective diameter) of less than or equal to 1,000 micrometers, more typically less than or equal to 100 micrometers. The plurality of particles may be distinguished from the nanoparticles by relative size, wherein the plurality of particles comprises particles that are larger than the nanoparticles. The term “nanoparticle” as used herein (unless an individual context specifically implies otherwise) will generally refer to particles, groups of particles, particulate molecules such as small individual groups or loosely associated groups of molecules, and groups of particulate molecules that while potentially varied in specific geometric shape have an effective, or average, diameter that can be measured on a nanoscale (less than 100 nanometers).

Exemplary nanoparticles include surface modified (i.e., nanoparticles that have a substance reacted to the respective surfaces thereof by at least one of covalent or acid/base bonding)) and non-surface modified nanoparticles (i.e., nanoparticles that do not have a substance reacted to the respective surfaces thereof by at least one of covalent or acid/base bonding). In some embodiments, the plurality of nanoparticles includes both surface modified nanoparticles and non-surface modified nanoparticles. In another aspect, in some embodiments, the nanoparticles are organic and/or inorganic (e.g., an inorganic core with an organic outer layer or an organic core with an inorganic outer layer).

Exemplary non-surface modified nanoparticles (e.g., nanospheres) include inorganic (e.g., calcium phosphate, hydroxy-apatite, metal oxides (e.g., zirconia, titania, silica, ceria, alumina, iron oxide, vanadia, zinc oxide, antimony oxide, tin oxide, and alumina-silica), metals (e.g., gold, silver, or other precious metals) and organic (e.g., insoluble sugars (e.g., lactose, trehalose (disaccharide of glucose), glucose, and sucrose), insoluble aminoacids, and polystyrene)) nanoparticles. Exemplary non-surface modified organic nanoparticles also include buckminsterfullerenes (fullerenes), dendrimers, branched and hyperbranched “star” polymers such as 4, 6, or 8 armed polyethylene oxide (available, for example, from Aldrich Chemical Company, Milwaukee, Wis. or Shearwater Corporation, Huntsville, Ala.) whose surface has been chemically modified. Specific examples of fullerenes include C₆₀, C₇₀, C₈₂, and C₈₋₄. Specific examples of dendrimers include polyamidoamine (PAMAM) dendrimers of Generations 2 through 10 (G2-G10), available also, for example, from Aldrich Chemical Company.

In one exemplary embodiment, a class of surface-modified nanoparticles utilized in the present invention are comprised of a core material and a surface that is different or modified from the core material. The core material may be inorganic or organic and is selected such that, as described in more detail herein, it is compatible with the first and second plurality of particles with which it is combined and it is suitable for the application for which it is intended. Generally the selection of the core material will be governed at least in part by the specific performance requirements for the composition and any more general requirements for the intended application. For example, the performance requirements for the solid composition might require that a given core material have certain dimensional characteristics (size and shape), compatibility with the surface modifying materials along with certain stability requirements (insolubility in a processing or mixing solvent). Other requirements might be prescribed by the intended use or application of the solid composition. Such requirements might include, for example, biocompatibility or stability under more extreme environments, such as high temperatures.

Suitable inorganic nanoparticle core materials include calcium phosphate, hydroxy-apatite, and metal oxide nanoparticles such as zirconia, titania, silica, ceria, alumina, iron oxide, vanadia, zinc oxide, antimony oxide, tin oxide, alumina/silica, and combinations thereof. Metals such as gold, silver, or other precious metals can also be utilized as solid particles or as coatings on organic or inorganic particles.

Suitable organic nanoparticle core materials include organic polymeric nanospheres, insoluble sugars such as lactose, trehalose, glucose or sucrose, and insoluble aminoacids. In another embodiment, another class of organic polymeric nanospheres includes nanospheres that comprise polystyrene, such as those available from Bangs Laboratories, Inc. of Fishers, In as powders or dispersions. Such organic polymeric nanospheres will generally have average particle sizes ranging from 20 nanometers to not more than 60 nanometers.

It will be understood that the selected nanoparticle core material may be used alone or in combination with one or more other nanoparticle core materials including mixtures and combinations of organic and inorganic nanoparticle materials. Such combinations may be uniform or have distinct phases, which can be dispersed or regionally specific, such as layered or of a core-shell type structure. The selected nanoparticle core material, whether inorganic or organic, and in whatever form employed, will generally have an average particle diameter of less than 100 nanometers. In some embodiments, nanoparticles may be utilized having a smaller average effective particle diameter of, for example less than or equal to 50, 40, 30, 20, 15, 10 or 5 nanometers; in some embodiments from 2 nanometers to 20 nanometers; in still other embodiments from 3 nanometers to 10 nanometers. If the chosen nanoparticle or combination of nanoparticles are themselves aggregated, the maximum preferred cross-sectional dimension of the aggregated particles will be within any of these stated ranges.

In an exemplary embodiment, another class of surface modified organic nanoparticles includes buckminsterfullerenes (fullerenes), dendrimers, branched and hyperbranched “star” polymers such as 4, 6, or 8 armed polyethylene oxide (available, for example, from Aldrich Chemical Company or Shearwater Corporation) whose surface has been chemically modified. Specific examples of fullerenes include C₆₀, C₇₀, C₈₂, and C₈₄. Specific examples of dendrimers include polyamidoamine (PAMAM) dendrimers of Generations 2 through 10 (G2-G10), available also from, for example, Aldrich Chemical Company.

In some applications it may be desirable for the surface modified nanoparticles to be substantially spherical in shape. In other application, however, more elongated shapes by be desired. Aspect ratios less than or equal to 10 are considered preferred, with aspect ratios less than or equal to 3 generally more preferred. The core material will substantially determine the final morphology of the particle and thus a significant influence in selection of the core material may be the ability to obtain a desired size and shape in the final particle.

The surface of the selected surface-modified nanoparticle core material will generally be chemically or physically modified in some manner. Both direct modification of a core surface as well as modification of a permanent or temporary shell on a core material are envisioned. Such modifications may include, for example, acid-base bonding, covalent chemical bonding, hydrogen bonding, electrostatic attraction, London forces and hydrophilic or hydrophobic interactions so long as the interaction is maintained at least during the time period required for the nanoparticles to achieve their intended utility. The surface of a nanoparticle core material may be modified with one or more surface modifying groups. The surface modifying groups may be derived from myriad surface modifying agents. Schematically, surface modifying agents may be represented by the following general formula:

A-B (II)

The A group in Formula II is a group or moiety that is capable of attaching to the surface of the nanoparticle. In those situations where the nanoparticle and/or bulk powder material is processed in solvent, the B group is a compatibilizing group with whatever solvent is used to process the nanoparticles and the first and second plurality of particles. In those situations where the nanoparticles and/or the first and second plurality of particles are not processed in solvent, the B group is a group or moiety that is capable of preventing irreversible agglomeration of the nanoparticle. The compatibilizing group may be reactive, but is generally non-reactive, with a component of the first and second plurality of particles. It is understood that the attaching composition may be comprised of more than one component or created in more than one step (e.g., the A composition may be comprised of an A′ moiety which is reacted with the surface, followed by an A″ moiety which can then be reacted with B). The sequence of addition is not important (i.e., the A′A″B component reactions can be wholly or partly performed prior to attachment to the core). Further description of nanoparticles in coatings can be found in Linsenbuhler, M. et. al., Powder Technology, 158, 2003, pp. 3-20.

Many suitable classes of surface-modifying agents are known to those skilled in the art and include silanes, organic acids, organic bases, and alcohols, and combinations thereof.

In another embodiment, surface-modifying agents include silanes. Examples of silanes include organosilanes such as alkylchlorosilanes; alkoxysilanes (e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, isooctyltrimethoxysilane, phenyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri(t-butoxy)silane, vinyltris(isobutoxy)silane, vinyltris(isopropenoxy)silane, and vinyltris(2-methoxyethoxy)silane; trialkoxyarylsilanes; isooctyltrimethoxy-silane; N-(3-triethoxysilylpropyl)methoxyethoxyethoxy ethyl carbamate; N-(3-triethoxysilylpropyl) methoxyethoxyethoxyethyl carbamate; silane functional (meth)acrylates (e.g., 3-(methacryloyloxy)propyltrimethoxysilane, 3-acryloyloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy)methyltriethoxysilane, 3-(methacryloyloxy)methyltrimethoxysilane, 3-(methacryloyloxy)propyldimethylethoxysilane, 3-(methacryloyloxy)propenyltrimethoxysilane, and 3-(methacryloyloxy)propyltrimethoxysilane)); polydialkylsiloxanes (e.g., polydimethylsiloxane); arylsilanes (e.g., substituted and unsubstituted arylsilanes); alkylsilanes (e.g., substituted and unsubstituted alkyl silanes (e.g., methoxy and hydroxy substituted alkyl silanes)), and combinations thereof.

Methods of surface-modifying silica using silane functional (meth)acrylates are known and are described, for example, in U.S. Pat. No. 4,491,508 (Olson et al.), U.S. Pat. No. 4,455,205 (Olson et al.), U.S. Pat. No. 4,478,876 (Chung), U.S. Pat. No. 4,486,504 (Chung), and U.S. Pat. No. 5,258,225 (Katsamberis). Surface-modified silica nanoparticles include silica nanoparticles surface-modified with silane surface modifying agents (e.g., acryloyloxypropyl trimethoxysilane, 3-methacryloyloxypropyltrimethoxysilane, 3-mercaptopropyltrimethoxysilane, n-octyltrimethoxysilane, isooctyltrimethoxysilane, and combinations thereof). Silica nanoparticles can be treated with a number of surface modifying agents (e.g., alcohol, organosilane (e.g., alkyltrichlorosilanes, trialkoxyarylsilanes, trialkoxy(alkyl)silanes, and combinations thereof), and organotitanates and mixtures thereof).

In another embodiment, organic acid surface-modifying agents include oxyacids of carbon (e.g., carboxylic acid), sulfur and phosphorus, acid derivatized poly(ethylene) glycols (PEGs) and combinations of any of these. Suitable phosphorus containing acids include phosphonic acids (e.g., octylphosphonic acid, laurylphosphonic acid, decylphosphonic acid, dodecylphosphonic acid, and octadecylphosphonic acid), monopolyethylene glycol phosphonate and phosphates (e.g., lauryl or stearyl phosphate). Suitable sulfur containing acids include sulfates and sulfonic acids including dodecyl sulfate and lauryl sulfonate. Any such acids may be used in either acid or salt forms.

Non-silane surface modifying agents include acrylic acid, methacrylic acid, beta-carboxyethyl acrylate, mono-2-(methacryloyloxyethyl) succinate, mono(methacryloyloxypolyethyleneglycol) succinate and combinations of one or more of such agents. In another embodiment, surface-modifying agents incorporate a carboxylic acid functionality such as CH₃O(CH₂CH₂O)₂CH₂COOH (hereafter, MEEAA), 2-(2-methoxyethoxy)acetic acid having the chemical structure CH₃OCH₂CH₂OCH₂COOH (hereafter MEAA), mono(polyethylene glycol) succinate in either acid or salt form, octanoic acid, dodecanoic acid, steric acid, acrylic and oleic acid or their acidic derivatives. In a further embodiment, surface-modified iron oxide nanoparticles include those modified with endogenous fatty acids (e.g., steric acid) or fatty acid derivatives using endogenous compounds (e.g., steroyl lactylate or sarcosing or taurine derivatives). Further surface modified zirconia nanoparticles can include a combination of oleic acid and acrylic acid adsorbed onto the surface of the particle.

Organic base surface-modifying agents may also include alkylamines (e.g., octylamine, decylamine, dodecylamine, octadecylamine, and monopolyethylene glycol amines). Other non-silane surface modifying agents include acrylic acid, methacrylic acid, beta-carboxyethyl acrylate, mono-2-(methacryloyloxyethyl) succinate, mono(methacryloyloxypolyethyleneglycol) succinate, and combinations of one or more of such agents.

Surface-modifying alcohols and thiols may also be employed including aliphatic alcohols (e.g., octadecyl, dodecyl, lauryl and furfuryl alcohol), alicyclic alcohols (e.g., cyclohexanol), and aromatic alcohols (e.g., phenol and benzyl alcohol), and combinations thereof. Thiol-based compounds are especially suitable for modifying cores with gold surfaces.

The surface-modified nanoparticles are selected in such a way that compositions formed with them are free from a degree of particle agglomeration or aggregation that would interfere with the desired properties of the composition. The surface-modified nanoparticles are generally selected to be either hydrophobic or hydrophilic such that, depending on the character of the processing solvent or the first and second plurality of particles, the resulting mixture or blend exhibits enhanced flowability.

Suitable surface groups constituting the surface modification of the utilized nanoparticles can thus be selected based upon the nature of the processing solvents and bulk materials used and the properties desired of the resultant combination. When a processing solvent is hydrophobic, for example, one skilled in the art can select from among various hydrophobic surface groups to achieve a surface-modified particle that is compatible with the hydrophobic solvent; when the processing solvent is hydrophilic, one skilled in the art can select from various hydrophilic surface groups; and, when the solvent is a hydrofluorocarbon or fluorocarbon, one skilled in the art can select from among various compatible surface groups; and so forth. The nature of the first and second plurality of particles and the desired final properties can also affect the selection of the surface composition. The composition may include two or more different nanoparticles such as one having hydrophilic groups thereon, and another having hydrophobic groups thereon. In another aspect, a nanoparticle can include two or more different surface groups (e.g., a combination of hydrophilic and hydrophobic groups) that combine to provide a nanoparticle having a desired set of characteristic. The surface groups will generally be selected to provide a statistically averaged, randomly surface modified particle.

The surface groups will be present on the surface of the particle in an amount sufficient to provide surface-modified nanoparticles with the properties necessary for compatibility with the first and second plurality of particles. In an exemplary embodiment, the surface groups are present in an amount sufficient to form a monolayer, and in another embodiment, a continuous monolayer, on the surface of at least a substantial portion of the nanoparticle.

A variety of methods are available for modifying the surfaces of nanoparticles. A surface modifying agent may, for example, be added to nanoparticles (e.g., in the form of a powder or a colloidal dispersion) and the surface modifying agent may be allowed to react with the nanoparticles. One skilled in the art will recognize that multiple synthetic sequences to bring the nanoparticle together with the compatibilizing group are possible and are envisioned within the scope of the present invention. For example, the reactive group/linker may be reacted with the nanoparticle followed by reaction with the compatibilizing group. Alternatively, the reactive group/linker may be reacted with the compatibilizing group followed by reaction with the nanoparticle. Other surface modification processes are described, for example, in U.S. Pat. No. 2,801,185 (Iler) and U.S. Pat. No. 4,522,958 (Das et al.).

Surface-modified nanoparticles or precursors to them may be in the form of a colloidal dispersion. Some such dispersions are commercially available as unmodified silica starting materials, for example, those nano-sized colloidal silicas available under the product designations “NALCO 1040,” “NALCO 1050,” “NALCO 1060,” “NALCO 2326,” “NALCO 2327,” and “NALCO 2329” colloidal silica from Nalco Co., Naperville, Ill. Metal oxide colloidal dispersions include colloidal zirconium oxide, suitable examples of which are described, for example, in U.S. Pat. No. 5,037,579 (Matchett), and colloidal titanium oxide, examples of which are described, for example, in U.S. Pat. No. 6,329,058 (Arney et al.) and U.S. Pat. No. 6,432,526 (Arney et al.). Such particles are also suitable substrates for further surface modification as described above. Additional details for making surface-modified nanoparticle dispersions can be found, for example, in U.S. Pat. No. 6,586,483 (Kolb et al.).

Exemplary first and second (and any additional) plurality of particles include organic and/or inorganic particles. In some embodiments, the particles may comprise both organic and inorganic material (e.g., particles having inorganic cores with an outer layer of organic material thereon).

Exemplary organics include polymers, lactose, medicaments, pigments, additives, fillers, excipients (e.g., microcrystalline cellulose (and other natural or synthetic polymers)), lactose monohydrate and other sugars, exfolients, cosmetic ingredients, aerogels, foodstuffs, and toner materials. Exemplary inorganics include abrasives, metals, ceramics (including beads, bubbles, and microspheres), pigments, additives, fillers (e.g., carbon black, titanium dioxide, calcium carbonate, dicalcium phosphate, nepheline (available, for example, under the trade designation “MINEX” from Unimin Corp, New Canaan, Conn.), feldspar and wollastonite), excipients, exfolients, cosmetic ingredients, and silicates (e.g., talc, clay, and sericite).

Exemplary polymers include poly(vinyl chloride), polyester, poly (ethylene terephthalate), polypropylene, polyethylene, poly vinyl alcohol, epoxies, polyurethanes, polyacrylates, polymethacrylates, and polystyrene. Polymeric particles can be made using techniques known in the art and/or are commercially available, for example, under the trade designation “POLY(VINYL CHLORIDE), SECONDARY STANDARD” from Sigma-Aldrich Chemical Company.

Exemplary classes of organic pigments include phthalocyanine, diarylamide, pyrazolone, isoindolinone, isoinoline, carbazole, anthraquinone, perylene and anthrapyrimidine. Exemplary organic pigments can be made using techniques known in the art and/or are commercially available, for example, under the trade designation “ORCOBRIGHT FLUORESCENT YELLOW GN 9026” from Organic Dyestuffs Corporation, Concord, N.C. Inorganic pigments include titania, carbon black, Prussian Blue, iron oxide, zinc oxide, zinc ferrite, and chromium oxide. Exemplary inorganic pigments can be made using techniques known in the art and/or are commercially available, for example, under the trade designation “BAYFERROX” from Lanxess Corporation, Akron, Ohio.

Exemplary ceramics include aluminates, titanates, zirconates, silicates, doped (e.g., lanthanides, and actinide) versions thereof, and combinations thereof. Exemplary ceramic particles can be made using techniques known in the art and/or are commercially available. Exemplary ceramic bubbles and ceramic microspheres are described, for example, in U.S. Pat. No. 4,767,726 (Marshall) and U.S. Pat. No. 5,883,029 (Castle). Examples of commercially available glass bubbles include those marketed by 3M Company, St. Paul, Minn. under the designation “3M SCOTCHLITE GLASS BUBBLES” (e.g., grades K1, K15, S15, S22, K20, K25, S32, K37, S38, K46, S60/10000, S60HS, A16/500, A20/1000, A20/1000, A20/1000, A20/1000, H50/10000 EPX, and H50/10000 (acid washed)); glass bubbles marketed, for example, by Potter Industries, Valley Forge, Pa., under the trade designation “SPHERICEL” (e.g., grades 110P8 and 60P18) “LUXSIL”, and “Q-CEL” (e.g., grades 30, 6014, 6019, 6028, 6036, 6042, 6048, 5019, 5023, and 5028); hollow glass microspheres marketed, for example, under the trade designation “DICAPERL” by Grefco Minerals, Bala Cynwyd, Pa., (e.g., grades HP-820, HP-720, HP-520, HP-220, HP-120, HP-900, HP-920, CS-10-400, CS-10-200, CS-10-125, CSM-10-300, and CSM-10-150); and hollow glass particles, for example, marketed by Silbrico Corp., Hodgkins, Ill., under the trade designation “SIL-CELL” (e.g., grades SIL 35/34, SIL-32, SIL-42, and SIL-43). Examples of commercially available ceramic microspheres include ceramic hollow microspheres, for example, marketed by Sphere One, Inc., Chattanooga, Tenn., under the trade designation, “EXTENDOSPHERES” (e.g., grades SG, CG, TG, SF-10, SF-12, SF-14, SLG, SL-90, SL-150, and XOL-200); and ceramic microspheres marketed, for example, by 3M Company under the trade designation “3M CERAMIC MICROSPHERES” (e.g., grades G-200, G-400, G-600, G-800, G-850, W-210, W-410, and W-610).

Each of the first and second (and any additional) plurality of particles may contain any one or mixture of particles for which a desired degree of flowability is desired. Generally, each plurality of particles will have median particle size diameters less than 200 micrometers, but greater than 100 nanometers. In some instances, each plurality of particles may have median particle size diameters less than 100 nanometers in size, but larger than the nanoparticles. In one embodiment, each plurality of particles will have median particle size diameters ranging from 0.5 micrometer to 200 micrometers, preferably from 1 micrometer to 200 micrometers, and more preferably from 1 micrometer to 100 micrometers.

The concentration of nanoparticles in a first composition and compositions made according to the present invention will depend, for example, on the desired dispersibility, floodability, flowability, fluidization, packing factor, tap density, bulk volume, or entrained gas of the plurality of particles then, the effectivenesss of the nanoparticles (including the particular nanoparticels used) in providing the desired dispersibility, floodability, flowability, fluidization, packing factor, tap density, bulk volume, or entrained gas of the plurality of particles therein, and the presence or absence of other adjuvants or excipients.

For example, the nature of the nanoparticle surface, the morphology of the particle and particle size may each influence the desired properties of the first composition, compositions made according to the present invention, the selection of the nanoparticles, and the amount or concentration of nanoparticle used. The presence of as little as 0.001 percent of nanoparticle by weight of a composition can achieve an improvement in dispersibility, floodability, flowability, fluidization, packing factor, or tap density, or decrease in bulk volume or entrained gas. Generally, the nanoparticle will be present in an amount of less than or equal to 10 weight percent; in some embodiments less than or equal to 5 weight percent; less than or equal to 1 weight percent; or less than 0.1 weight percent. In some embodiments, the amount of surface-modified nanoparticles is from 0.001 to 20 percent; from 0.001 to 10 percent; from 0.001 to 1 percent; from 0.001 to 0.01 percent; or from 0.01 to 1 percent, by weight of the composition.

In many applications it may be desirable to select nanoparticles that are substantially spherical. It will be understood that such selection and optimization of component compositions will be within the skill of those in the art who are familiar with the physical properties required for the composition in a given use or application.

First compositions and compositions made according to the present invention will generally be prepared by mixing the first plurality of particles with the nanoparticles using any suitable, conventional mixing or blending process. In one embodiment, the nanoparticles are prepared as a dispersion in an organic solvent, and the first plurality of particles is added to the dispersion. Typical solvents that may be employed include, for example, toluene, isopropanol, heptane, hexane, octane, and water

In another embodiment, the plurality of particles are first at least partially dispersed in a suspending liquid (e.g., a solvent), and then the nanoparticles are blended. In another embodiment, the nanoparticles and mixing the first plurality of particles are blended as powders (e.g., dry blended).

Compositions made according to the methods described in the present invention can be used, for example, as additives to improve the dispersibility, floodability, flowability, fluidization, packing factor, and/or tap density of powders or pellets, such as polymers, when these powders of pellets are required to be processed through an extruder. Additionally, for example, the compositions according to the methods of the present invention can also be used to formulate medicaments when there is a need for improved dispersibility or flowability, for example in a metered dose inhaler.

The following examples are offered to aid in the understanding of the present invention and are not to be construed as limiting the scope thereof. Unless otherwise indicated, all parts and percentages are by weight.

### EXAMPLES

Unless otherwise noted, all reagents and solvents were or can be obtained from Aldrich Chemical Co., Milwaukee, Wis.

### Test Method for Bulk Solids Characterization by Carr Indices; ASTM D6393-99

This test method is often referred to as Carr Indices. It provides measurements that can be used to describe the bulk properties of a powder or granular material.

The test method is suitable for free flowing and moderately cohesive powders and granular materials up to 2.0 mm in size. Materials must be able to pour through a 7.0±1.0-mm diameter funnel outlet when in an aerated state.

Eight measurements and two calculations provide ten tests for Carr Indices. Each individual test or a combination of several tests can be used to characterize the properties of bulk solids. These ten tests are as follows:

Test A—Measurement of Carr Angle of Repose

Test B—Measurement of Carr Angle of Fall

Test C—Calculation of Carr Angle of Difference

Test D—Measurement of Carr Loose Bulk Density

Test E—Measurement of Carr Packed Bulk Density

Test F—Calculation of Carr Compressibility

Test G—Measurement of Carr Cohesion

Test H—Measurement of Carr Uniformity

Test I—Measurement of Carr Angle of Spatula

Test J—Measurement of Carr Dispersibility

### Terminology

(i) Carr angle of difference is the difference between the Carr angle of repose and Carr angle of fall.

(ii) Carr angle of fall is an angle of repose measured from a powder heap to which a defined vibration has been given.

(iii) Carr angle of repose is a measurement from the powder heap built up by dropping the material through a vibrating sieve and funnel above a horizontal plate.

(iv) Carr angle of spatula is a measurement by which a spatula is inserted into a powder heap parallel to the bottom and then lifting it up and out of the material.

(v) Carr cohesion is a descriptive measure of interparticle forces based on the behavior of the material during sieving.

(vi) Carr compressibility is a calculation made by using Carr loose bulk density and Carr packed bulk density.

(vii) Carr dispersibility is a measurement by which a powder sample is dropped through a hollow cylinder above a watch glass and then the amount of powder collected by the watch glass is measured.

(viii) Carr dynamic bulk density is a calculated bulk density of a material. It is used to compute vibration time for the Carr cohesion measurement.

(ix) Carr loose bulk density is a measurement obtained by sieving the sample through a vibrating chute to fill a measuring cup.

(x) Carr packed bulk density is a measurement obtained by dropping a measuring cup, which is filled with the sample, a specific number of times from the same height. This is sometimes referred to as a tapped density.

(xi) Carr uniformity is a measurement calculated from the particle size distribution of the powder as measured by sieving.

### Apparatus

The Carr Index measurement instrument (obtained from Hosokawa International Inc., New York, N.Y.) included a timer, a vibrating mechanism, an amplitude gage, a rheostat, and a tapping device. The timer was used to control the duration of vibration and the number of taps. The vibrating mechanism, delivered vibration at 50 to 60 Hz to the vibration plate at an amplitude of 0.0 to 3.0 mm. The amplitude gauge was mounted on the vibration plate to measure the amplitude of the vibration (in the range of from 0.0 to 4.0 mm). The rheostat dial was used to adjust the vibration amplitude of vibration plate (in the range from 0.0 to 3.0 mm). The tapping device, consisted of tap holder and tapping lift bar (tapping pin), which lifted and free-fall dropped a measuring cup a stroke of 18.0±0.1 mm and at a rate of 1.0+0.2 taps/s. The spatula assembly consisted of a (i) spatula blade, (ii) a pan base/elevator stand, and (iii) a shocker. The spatula blade was a chrome-plated brass plate mounted on the blade receiver to retain powder while the elevator stand lowered the powder-filled pan. The dimensions of the spatula blade were 80 to 130 mm length, 22.0±0.3-mm width and 3.0±0.3-mm thick. The shocker was a sliding bushing with a mass of 110.0±1.0 g at a drop height of 150.0±10.0 mm, measured from the lower edge of the bushing to the shocker base for the measurement of angle of spatula. The total mass of the shocker assembly including the sliding bushing, pole, spatula blade, and blade receiver was 0.65±0.35 kg.

The dispersibility measuring unit consisted of container comprising (i) a shutter cover, (ii) a cylindrical glass tube, and (iii) a watch glass. The container was a hopper unit with a shutter cover at the bottom to support a powder sample. The shutter cover opened horizontally to release the powder sample which fell through the glass tube onto the watch glass. The cylindrical glass tube was located vertically 170.0±10.0 mm under the shutter cover to confine the scattering/dispersed powder. The dimension of the tube was 100.0±5.0-mm diameter and 330.0±10.0-mm length. The watch glass was centered 101.0±1.0 mm under the cylindrical glass tube to collect undispersed powder. The dimension of watch glass was 100.0±5.0-mm diameter and 2.0±0.1-mm thickness with the radius of curvature of 96.3 mm, concaved upwards.

### Accessories:

The spatula pan was a stainless steel pan with at least a 100.0-mm width, a 125.0-mm length, a 25.0 mm height, and a 1.0-mm thickness, and was used to retain powder for the preparation of the measurement of Carr angle of spatula. The scoop was a stainless steel container used to transport powder. The scraper was a stainless steel plate and was used to scrape off excess powder in the cup. The cup was a 100-ml stainless steel cylindrical container with the inside dimensions of 50.5±0.1-mm diameter and 49.9±0.1-mm height and was used for Carr bulk density measurement. The wall thickness of the cup was 1.75±0.25 mm. The interior cup walls were sufficiently smooth such that machining marks were not evident. The cup extension had an acetal polyoxy methylene (obtained from DuPont, Wilmington Del., under the trade designation “DELRIN”) extension sleeve for the 100 ml measuring cup, 55.0±0.1 mm in diameter by 48.0±1.0 mm in height. The funnel for angle of repose was a glass funnel with 55° angle bowls as measured from the horizontal, 7.0±1.0-mm bottom outlet diameter and outlet stem length 33.5 mm for the measurement of Carr angle of repose.

The stationary chute was a stainless steel conical chute with the dimensions of 75.0-mm top diameter, 55.0-mm height, and 50.0-mm bottom diameter to guide the powder flow into the measuring cup. The vibration chute was a stainless steel conical chute with the dimensions of 75.0-mm top diameter, 55.0-mm height, and 50.0-mm bottom diameter installed on the vibration plate to guide the powder flow to the stationary chute or cup extension. The sieves were certified 76.0-mm diameter stainless steel sieves with the opening of 710 micrometers, 355 micrometers, 250 micrometers, 150 micrometers, 75 micrometers, and 45 micrometers. The sieve extension was a stainless steel extension piece used as a spacer in the vibration unit when only one sieve was used. The spacer ring is a white acetal polyoxy methylene (obtained from DuPont, Wilmington Del., under the trade designation “DELRIN”) spacer inserted between sieve and vibration chute or glass funnel to protect them from damage. The sieve holding bar was a chrome-plated brass holding bar used to hold the sieve assembly on the vibration plate. The pan, with a base for tapping device, measuring cup, and shocker was a stainless steel pan (210.0-mm length, 150.0-mm width, 35.0-mm height, and 1.0-mm thickness), and was designed to accept tapping device, measuring cup and platform, as well as provide a stand base for shocker.

The platform was a chrome-plated brass circular platform with a diameter of 80.0±0.3 mm and a height of 59.0±2.0 mm, and was used for the measurement of Carr angle of repose. The shocker was a sliding bushing with a mass of 110.0±1.0 g at a drop height of 150.0±10.0 mm, measured from the lower edge of the bushing to the shocker base for the measurement of Carr angle of fall. The total mass of the shocker, platform, and pan for the measurement of angle of fall was 1.35±0.25 kg. The pan had molded-in feet so it was slightly raised from the table top. The cover, for measuring dispersibility was a removable enclosure to confine the dust of sample powder when it fell onto the watch glass for the measurement of Carr dispersibility. The balance was capable of measuring sample mass to an accuracy of ±0.01 g with a maximum of 2.0 kg. A computer was used to guide the measuring operation, collect data, calculate data, and print test results.

### Procedure

The treated nanoparticle sample was riffled carefully into portions for each of the following measurements. All the measurements were performed on a strong, horizontally-leveled laboratory bench.

### Test A Carr Angle of Repose

The following parts were placed onto the vibration plate in the following order, starting at the bottom: glass funnel, spacer ring, sieve (with 710 micrometers opening), sieve extension; and sieve holding bar. The vibration assembly was fastened with knob nuts located on both sides of sieve holding bar and the platform was centered under the glass funnel. The glass funnel was positioned 76.0±1.0 from the stem end of the glass funnel mm above the platform and 180 s on 60 Hz vibrating frequency was selected on the timer.

Approximately 250 ml of treated sample was poured over the sieve using the scoop and the vibration adjustment dial (Rheostat) was set to 0. The vibrating mechanism and timer was switched on and vibration amplitude was gradually increased (to no more than 0.2 mm at a time), by incrementally turning the vibration adjustment dial until powder starts to flow out of the end of the glass funnel and builds up on the circular platform in a conical shape. The vibration mechanism was turned off when the powder starts to fall from the edge of the platform and the powder pile was completely formed. If a conical shape was not completely formed, the powder pile was removed and previous steps were repeated. After the cone has been built up, calculate an average angle of the cone (from horizontal) in relation to the edge of the platform by the equation below. This average angle is called the Carr angle of repose.

Carr Angle of Repose=tan⁻¹[H/R]

where:

H=Height of the powder pile, mm, and R=Radius of the circular platform, mm.

The shape of the cone was always straight.

### Test B—Carr Angle of Fall

After determining the Carr Angle of Repose as above, the shocker was placed on the shocker base and the sliding bushing was carefully raised (so that the cone will not be disturbed) to the upper end of the pole (at a drop height of 150.0±10.0 mm) and allowed to fall to give a shock to the pan. This was repeated three times. The powder layer collapsed and exhibit a smaller angle of repose. Thirty seconds after the final shock, measure the angle as described above. This new, lower angle is called Carr angle of fall.

### Test C—Calculation of Carr Angle of Difference

The Carr angle of fall was subtracted from the Carr angle of repose to obtain the Carr angle of difference.

### Test D—Carr Loose Bulk Density

The parts were placed onto the vibration plate in the following order, starting at the bottom: (i) the vibration chute, (ii) the spacer ring, (iii) the sieve with opening of 710 micrometers, (iv) sieve extension; and, (v) sieve holding bar. The vibration assembly was fastened with knob nuts located on both sides of sieve holding bar. The stationary chute was supported below the vibration chute and the pan was placed directly under the stationary chute and positioned with the measuring cup in its base. The center of the measuring cup was in alignment below the center of the stationary chute with a distance between them of 30.0±5.0 mm. The scoop was used to pour 200 to 300 ml of the powder onto the sieve and the vibration time of 30 seconds was set on timer, with the vibration adjustment dial (rheostat) set to 0. The vibrating mechanism and timer were then turned on and the .amplitude of vibration was adjusted to control the powder flow rate so that the powder will fill the cup within 20 to 30 s. The vibration was terminated when the cup was filled and overflowing.

Using the scraper, excess material was scraped from the top of the cup. Weigh the cup and powder were weighed. Subtracting the empty cup mass from that of cup with powder yields a difference, when divided by 100 results in the Carr loose bulk density in g/cm³. (The cup is exactly 100 ml in volume). The previous steps were repeated three times to obtain an average value.

### Test E—Carr Packed Bulk Density

This test is also known in the field as a tapped bulk density even though the sample was dropped instead tapped.

The parts were prepared in the same order as with the measurement for Carr loose bulk density without using the stationary chute. The cup extension was placed on the top of the measuring cup. And the cup was filled to the top with the scoop with treated sample and placed on the tapping device. The timer was set for a desired tapping duration of 180 s on 60 Hz power supply). The number of taps for consistent results was determined by repetitive tests in which the relationship between the tapped bulk density and number of taps is examined. The number of taps were sufficiently large so that additional taps do not result in an increase in tapped bulk density.

The tapping device was turned on. During the tapping period, it was necessary to observe the level of the powder and, add powder to the cup extension so that the final powder level was not below the rim of the measuring cup. When the tapping was completed, the cup and its extension was removed from the tapping device scraping off excessive powder from the cup surface as described above. The cup with the packed powder was weighed and the weight of the empty cup mass was subtracted from it. That difference, divided by 100, is the Carr packed bulk density of the powder in g/ml. (The cup is exactly 100 ml in volume).

### Test F—Carr Compressibility

The Carr compressibility value (C) was calculated using the following equation from the Carr loose bulk density (L), in 5.8 and the Carr packed bulk density (P) previously determined.

C=100(P−L)/P

### Test G—Carr Cohesion

FIG. 6 of the ASTM Method designates whether to use this Test G or rather to use Test H, below.

If Test G is used, the proper sieve sizes were selected for the ASTM method. The parts were placed on the vibration plate in the following order, starting at the bottom: (i) vibration chute, (ii) spacer ring, (iii) sieve 1 (smallest opening), (iv) sieve 2 (midsize opening), (v) sieve 3 (largest opening), and (vi) the sieve holding bar. The vibration assembly was fastened with knob nuts located on both sides of sieve holding bar. The vibrating mechanism was turned on and amplitude adjusted to achieve a vibration to 1.0 mm with vibration adjustment dial. When the vibration amplitude becomes stabilized, the vibration was turned of, keeping the position of vibration adjustment dial as it was.

The timer was set according to the vibration time calculated as follows:

T(s)=20+[(1.62−W)/0.016]

W=[P−L)C/100]+L

where:

T=Vibration time (seconds)

W=Carr dynamic bulk density, g/ml,

C=Carr compressibility, %,

L=Carr loose bulk density, g/ml, and

P 5 Carr packed bulk density, g/ml.

If Carr dynamic bulk density, W, is greater than 1.6 g/ml, vibration time, T, was set at 20 s.

2.0±0.01 grams of treated sample was placed on the top sieve and the vibration mechanism was turned on. Vibration was stopped after time T, and the knob nuts were loosened and the three sieves were removed and the amount of powder retained on each sieve was weighed.

The Carr Cohesion is calculated as follows:

[(Powder mass retained on the largest sieve)/2 g]×100

[Powder mass retained on the midsize sieve)/2 g]×100×(⅗)

[Powder mass retained on the smallest sieve)/2 g]×100×(⅕)

The sum of these three calculated values gives Carr cohesion [%].

### Test H—Carr Uniformity

From the particle size distribution curve, a particle size of which 60% of the powder by volume passes the sieve (d60) and a particle size of which 10% passes the sieve (d10) was determined.

Carr uniformity is calculated below:

Carr uniformity=d60/d10

### Test I—Carr Angle of Spatula

The Carr spatula assembly was used as described above. The spatula pan was put on the pan base and the pan was raised until the pan bottom contacts the spatula. The treated sample was poured into the pan so that the spatula is completely covered with several centimeters of material (about 250 ml on the spatula). The amount of material used for each measurement was consistent, that is, same depth of material over the spatula. The pan was slowly lowered away from the spatula. This exposed the spatula with a considerable amount of material on it.

An average angle Q, of the powder pile (from horizontal) in relation to the edge of spatula by the equation below and indicate the shape of the powder pile as previously described above is calculated using the following formula:

Θ=tan⁻¹[H/X]

where:

H=height of the powder pile on the spatula (mm) and

X=half width of the spatula (mm).

The sliding bushing was raised to the highest point of the pole (at a drop height of 150.0±10.0 mm), then dropped to give only one shock to the spatula. 30 seconds after the shock an average angle of the powder on the spatula was calculated again as described above. The mean angle of spatula before and after the shock was averaged to give the Carr angle of spatula.

### Test J—Carr Dispersibility

The apparatus was enclosed in a box to prevent ambient air currents from disturbing the measurement and to contain the powder. The Carr dispersibility measuring unit was set in place as described above. The watch glass was weighed and positioned concave upwards and centered under the glass tube. 10.0±0.01 grams of powder was weighed and placed into the hopper of the container. The shutter cover was released horizontally in 1 second, allowing the powder to fall through the glass tube and onto the watch glass. The watch glass and treated material was weighed.

Carr dispersibility value was obtained by the following calculation:

Carr dispersibility=(10 g−Mass of powder on watch glass)/10 g×100

### Carr Indices

Table 1 lists the Carr Indices for the results of Tests A, F, G, H, and I. Summation of the Carr Indices of Tests A, F, G, (or H) and I will result in the Flowability Index.

TABLE 1

| Angle of | | | | Angle of | | | | | |
|---|---|---|---|---|---|---|---|---|---|
| Repose | | Compress- | | Spatula | | Unifor- | | | |
| De- | | ibility | | De- | | mity | | Cohesion | |
| gree | Index | % | Index | gree | Index | No. | Index | % | Index |
| <25 | 25 | <5 | 25 | <25 | 25 | 1 | 25 | | |
| 26-29 | 24 | 6-9 | 23 | 26-30 | 24 | 2-4 | 23 | | |
| 30 | 22.5 | 10 | 22.5 | 31 | 22.5 | 5 | 22.5 | | |
| 31 | 22 | 11 | 22 | 32 | 22 | 6 | 22 | | |
| 32-34 | 21 | 12-14 | 21 | 33-37 | 21 | 7 | 21 | | |
| 35 | 20 | 15 | 20 | 28 | 20 | 8 | 20 | | |
| 36 | 19.5 | 16 | 19.5 | 39 | 19.5 | 9 | 19 | | |
| 37-39 | 18 | 17-19 | 18 | 40-44 | 18 | 10-11 | 18 | | |
| 40 | 17.5 | 20 | 17.5 | 45 | 17.5 | 12 | 17.5 | | |
| 41 | 17 | 21 | 17 | 46 | 17 | 13 | 17 | | |
| 42-44 | 16 | 22-24 | 16 | 47-59 | 16 | 14-16 | 16 | | |
| 45 | 15 | 25 | 15 | 60 | 15 | 17 | 15 | <6 | 15 |
| 46 | 14.5 | 26 | 14.5 | 61 | 14.5 | 18 | 14.5 | 6-9 | 14.5 |
| 47-54 | 12 | 27-30 | 12 | 62-74 | 12 | 19-21 | 12 | 10-29 | 12 |
| 55 | 10 | 31 | 10 | 75 | 10 | 22 | 10 | 30 | 10 |
| 56 | 9.5 | 32 | 9.5 | 76 | 9.5 | 23 | 9.5 | 31 | 9.5 |
| 57-64 | 7 | 33-36 | 6 | 77-89 | 7 | 24-26 | 7 | 32-54 | 7 |
| 65 | 5 | 37 | 5 | 90 | 5 | 27 | 5 | 55 | 5 |
| 66 | 4.5 | 38 | 4.5 | 91 | 4.5 | 28 | 4.5 | 56 | 4.5 |
| 67-89 | 2 | 39-45 | 2 | 92-99 | 2 | 29-35 | 2 | 57-59 | 2 |
| 90 | 0 | >45 | 0 | >99 | 0 | >35 | 0 | >79 | 0 |

Table 2 lists the Carr Indices for the flowability index (obtained from summing the values from Table 1), and Tests B, C, and J. Summation of the Carr index assigned to the Flowability Index and the Carr indices of Tests B, C, and J will result in the Floodability Index. Adding the Flowability Index and the Floodability Index will provide the total Carr Index for the solid.

TABLE 2

| Flow- | | Angle of | | Angle of | | Dispers- | |
|---|---|---|---|---|---|---|---|
| ability | | Fall | | Difference | | ibility | |
| Degree | Index | % | Index | Degree | Index | % | Index |
| >60 | 25 | <10 | 25 | >30 | 25 | <50 | 25 |
| 59-56 | 24 | 11-19 | 23 | 29-28 | 24 | 49-44 | 24 |
| 55 | 22.5 | 20 | 22.5 | 27 | 22.5 | 43 | 22.5 |
| 54 | 22 | 21 | 22 | 26 | 22 | 42 | 22 |
| 53-50 | 21 | 22-24 | 21 | 25 | 21 | 41-36 | 21 |
| 49 | 20 | 25 | 20 | 24 | 20 | 35 | 20 |
| 48 | 19.5 | 26 | 19.5 | 23 | 19.5 | 34 | 19.5 |
| 47-45 | 19.5 | 27-29 | 18 | 22-20 | 18 | 33-29 | 18 |
| 44 | 19.5 | 30 | 17.5 | 19 | 17.5 | 28 | 17.5 |
| 43 | 19.5 | 31 | 17 | 18 | 17 | 27 | 17 |
| 42-40 | 19.5 | 32-39 | 16 | 17-16 | 16 | 26-21 | 16 |
| 39 | 19.5 | 40 | 15 | 15 | 15 | 20 | 15 |
| 38 | 14.5 | 41 | 14.5 | 14 | 14.5 | 19 | 14.5 |
| 37-34 | 12 | 42-49 | 12 | 12 | 12 | 18-11 | 12 |
| 33 | 10 | 50 | 10 | 10 | 10 | 10 | 10 |
| 32 | 9.5 | 51 | 9 | 9.5 | 9.5 | 9 | 9.5 |
| 31-29 | 8 | 52-56 | 8 | 8 | 8 | 8 | 8 |
| 28 | 6.25 | 57 | 7 | 6.25 | 6.25 | 7 | 6.25 |

### Examples 1 and 2 and Comparative Example A

### Example 1

A surface modified nanoparticle dispersion (5 nm size, isooctyl/methyl surface modified) was prepared using the method described in U.S. Pat. No. 6,586,483 (Kolb et al.), under the heading “Preparation of isooctyl Surface Modified Silica Nanoparticles”, the disclosure of which is incorporated herein by reference were dried in an oven at 150° C. to remove solvent. 0.5 gram of the surface-modified nanoparticles were then added to 99.5 grams of a glass powder (D₅₀=6.0 micrometer; prepared as described in U.S. patent application Ser. No. 11/004,385, filed Dec. 3, 2004, the disclosure of which is incorporated by reference), and mixed using a fluid bed jet mill (Alpine Model 100 APG Mill, obtained from Hosokawa Micron Powder Systems, Summit, N.J.) to provide a first mixture. 20 grams of the first mixture was added to 180 grams of the glass powder, and mixed using the fluid bed jet (Alpine).

The resulting treated glass powder was characterized using the “Standard Test Method for Bulk Solids Characterization by Carr Indices; ASTM D6393-99” (described above) using Test A, B, C, D, E, F, G, I, and J. The Carr Indices were derived after the methods described by Carr in Chemical Engineering vol. 72, pp. 163-168 (1965), the disclosure of which is incorporated herein by reference. The results are reported in Table 3, below.

TABLE 3

| Test | Example | Comp. A | 1 | 2 |
|---|---|---|---|---|
| A | Angle of Repose | 54.3 (12) | 52.7 (12) | 44.3 (16) |
| | (°, Index) | | | |
| B | Angle of Fall | 35.0 (16) | 33.5 (16) | 33.2 (16) |
| | (°, Index) | | | |
| C | Angle of Difference | 19.3 (17.5) | 19.2 (17.5) | 11.1 (12) |
| | (°, Index) | | | |
| D | Loose Bulk Density | 0.374 | 0.483 | 0.6 |
| | (g/cm³) | | | |
| E | Packed Bulk Density | 0.861 | 0.958 | 0.974 |
| | (g/cm³) | | | |
| F | Compressibility | 56.6 (0) | 49.6 (0) | 38.4 (4.5) |
| | (%, Index) | | | |
| G | Cohesiveness | 98.6 (0) | 34.9 (7) | 11.3 (12) |
| | (%, Index) | | | |
| I | Angle of Spatula | 54.6 (16) | 53.8 (16) | 54.2 (16) |
| | (°, Index) | | | |
| J | Dispersibility | 7.0 (6.25) | 31.7 (18) | 69.6 (25) |
| | (%, Index) | | | |
| | Flowability Index | 28 | 35 | 48.5 |
| | Floodability Index | 46 | 63.5 | 73 |
| | Total Index | 74 | 98.5 | 121.5 |
| | (Carr Index) | | | |

### Example 2

A mixture of a surface modified nanoparticle dispersion (5 nm size, isooctyl/methyl surface modified) and a glass powder (D₅₀=6.0 micrometer) was prepared as described in Example 1, above. 40 grams of the first mixture was added to 160 grams of the glass powder.

The resulting treated glass powder was characterized as described in Example 1, and the results are reported in Table 3, above.

### Comparative Example A

200 grams (only) of the unmodified glass powder (D₅₀=6.0 micrometer) were prepared and characterized as described in Example 1, and the results are reported in Table 3, above.

### Examples 3 and 4 and Comparative Examples B and C

### Example 3

A surface modified nanoparticle dispersion (5 nm size, isooctyl/methyl surface modified) was prepared as described in Example 1, above. 10 grams of the surface modified nanoparticles were added to 90 grams of titanium dioxide (TiO₂), and mixed until completely blended (5 minutes) using a jar mill with cylindrical alumina grinding media.

The resulting treated TiO₂ was characterized using the “Standard Test Method for Bulk Solids Characterization by Carr Indices; ASTM D6393-99” (described above) to determine the angles of repose. The angles of repose was 38.8 degrees.

Fluidization, Δh, was measured using the following method. Using a fluidization measurement instrument (Sames Type AS100, obtained from Sames Electronic, Inc, Livonia, Mich.), the treated TiO₂ was added to the chamber to an initial height, hᵢₙᵢₜᵢₐₗ, of 1 cm. Compressed air (10 psi (69 kPa)) was passed through the chamber, and the final height h_{final} of the column was recorded. The resulting fluidization value, Δh, was calculated using the following formula:

Δh=h_{final}−hᵢₙᵢₜᵢₐₗ

The fluidization value was 1.1.

Further, the packing factor was determined as follows. A fully automated gas displacement pycnometer obtained under the trade designation “ACCUPYC 1330 PYCNOMETER” from Micromeritics, Norcross, Ga., was used to determine the true density (g/cm³) of the composite material and glass residual according to ASTM D-2840-69, “Average True Particle Density of Hollow Microspheres,” the disclosure of which is incorporated herein by reference.

Using a tap-pak volumeter (obtained under the trade designation “JEL” Tap-Pak Volumeter, from J. Engelsmann AG, Ludwigschafen, Germany), a known weight of sample, wtₛₐₘₚₗₑ, to be tested was poured into a graduated cylinder and tapped for 3,000 cycles. The bulk volume, V_{bulk}, was read off of the graduated cylinder to the nearest 5 cm³. The bulk density was determined using the following equation:

Bulk Density (g/cm³)=wtₛₐₘₚₗₑ/V_{bulk}.

The Packing Factor, in turn was determined using the following equation:

Packing Factor (%)=(Bulk Density/True Density)×100.

The packing factor was 20.1%.

This mixture can be added to a plurality of particles.

### Example 4

A surface modified nanoparticle dispersion (5 nm size, isooctyl/methyl surface modified) was prepared as described in Example 1, above. 10 grams of the surface-modified nanoparticles were added to 90 grams of titanium dioxide (TiO₂), and mixed until completely blended (5 minutes) using ajar mill with cylindrical alumina grinding media. 5 grams of the resulting mixture was added to 100 grams of TiO₂, and mixed until completely blended (5 minutes) using a jar mill with cylindrical alumina grinding media.

The resulting treated TiO₂ was characterized as described for Example 3, above. The angles of repose and packing factor were 43.8 degrees and 18.1%, respectively.

Fluidization, Δh, was measured as described in Example 3, above. The fluidization value was 0.6.

### Comparative Example B

100 grams (only) of the unmodified TiO₂ was characterized as described for Example 3, above. The angles of repose and packing factor were 41.2 degrees and 15.3%, respectively.

Fluidization, Δh, was measured as described in Example 3, above. The fluidization value was 0.5.

### Comparative Example C

A surface modified nanoparticle dispersion (5 nm size, isooctyl/methyl surface modified) was prepared as described in Example 1, above. 0.5 gram of the surface modified nanoparticles were added to 99.5 grams of titanium dioxide (TiO₂), and mixed until completely blended (5 minutes) using a jar mill with cylindrical alumina grinding media.

The resulting treated TiO₂ was characterized as described for Example 3, above. The angles of repose and packing factor were 43.8 degrees and 17.9%, respectively.

Fluidization, Δh, was measured as described in Example 3, above. The fluidization value was 0.5.

### Examples 5 and 6 and Comparative Examples D and E

### Example 5

A surface modified nanoparticle dispersion (20 nm size, isooctyl/methyl surface modified); was prepared using the method described in U.S. Pat. No. 6,586,483 (Kolb et al.) under the heading “Preparation of isooctyl Surface Modified Silica Nanoparticles”, the disclosure of which is incorporated herein by reference, and then dried in an oven at 150° C. to remove solvent. 5 grams of the surface-modified nanoparticles were added to 95 grams of glass powder (D₅₀=6.0 micrometer; prepared as described in U.S. patent application Ser. No. 11/004,385, the disclosure of which is incorporated by reference), and mixed until completely blended (5 minutes) using a jar mill with cylindrical alumina grinding media to provide a first mixture. 20 grams of the first mixture was added to 180 grams of the glass powder, and mixed using the jar mill.

The resulting treated glass powder was characterized as described in Example 3, above. The angles of repose, and packing factor were 40.6 degrees and 33.6%, respectively.

Fluidization, Δh, was measured as described in Example 3, above. The Fluidization value was 1.3.

### Example 6

A (first) mixture of surface modified nanoparticle dispersion (20 nm size, isooctyl/methyl surface modified) and glass powder (D₅₀=6.0 micrometer) was prepared as described for Example 5, above. 40 grams of the first mixture was added to 160 grams of the glass powder, and mixed using the jar mill.

The resulting treated glass powder was characterized as described in Example 3, above. The angles of repose, and packing factor were 46.7 degrees and 31.2%, respectively.

Fluidization, Δh, was measured as described in Example 3, above. The fluidization value was 0.5.

### Comparative Example D

Comparative Example D was prepared using only unmodified glass powder (200 grams, D₅₀=6.0 micrometer; prepared as described in U.S. patent application Ser. No. 11/004,385, the disclosure of which is incorporated herein by reference). The resulting unmodified glass powder was characterized as described in Example 3, above. The angles of repose, and packing factor were 47.7 degrees and 29.4%, respectively.

Fluidization, Δh, was measured as described in Example 3, above. The fluidization value was 0.

### Comparative Example E

A mixture of surface modified nanoparticle dispersion (20 nm size, isooctyl/methyl surface modified) and glass powder was prepared as described for Example 5, above, except 2 grams of the surface modified nanoparticles were added to 200 grams of the glass powder to provide the first mixture. 20 grams of the first mixture was added to 180 grams of the glass powder, and mixed using the jar mill.

The resulting treated glass powder was characterized as described in Example 3, above. The angles of repose, and packing factor were 49.9 degrees and 31.2%, respectively.

Fluidization, Δh, was measured as described in Example 3, above. The fluidization value was 0.2.

### Examples 7 and 8 and Comparative Examples F and G

### Example 7

A surface modified nanoparticle dispersion (20 nm size, isooctyl/methyl surface modified) was prepared as described in U.S. Pat. No. 6,586,483 (Kolb et al.), the disclosure of which is incorporated herein by reference) were dried in an oven at 150° C. to remove solvent. 5 grams of the surface modified nanoparticles were added to 95 grams of ceramic microspheres (obtained from 3M Company under the trade designation “3M W410 ZEOSPHERES”), and mixed until completely blended (5 minutes) using ajar mill with cylindrical alumina grinding media.

The resulting treated ceramic microspheres were characterized as described in Example 3, above. The angles of repose, and packing factor were 42.9 degrees and 42.7%, respectively.

Fluidization, Δh, was measured as described in Example 3, above. The fluidization value was 2.0.

This mixture can be added to a plurality of particles.

### Example 8

A first mixture was prepared as described in Example 7, above. 40 grams of the first mixture was added to 160 grams of the ceramic microspheres (“3M W410 ZEOSPHERES”), and mixed until completely blended (5 minutes) using a jar mill with cylindrical alumina grinding media.

The resulting treated ceramic microspheres were characterized as described in Example 3, above. The angles of repose, and packing factor were 47.7 degrees and 41.2%, respectively.

Fluidization, Δh, was measured as described in Example 3, above. The fluidization value was 0.7.

### Comparative Example F

200 grams of unmodified ceramic microspheres (“3M W410 ZEOSPHERES”) were characterized as described in Example 3, above. The angles of repose, and packing factor were 48.7 degrees and 39.7%, respectively.

Fluidization, Δh, was measured as described in Example 3, above. The fluidization value was 0.4.

### Comparative Example G

A surface modified nanoparticle dispersion (20 nm size, isooctyl/methyl surface modified) was prepared as described in Example 7, above. 2 grams of the surface modified nanoparticle were added to the 200 grams of ceramic microspheres (“3M W410 ZEOSPHERES”), and mixed until completely blended (5 minutes) using ajar mill with cylindrical alumina grinding media.

The resulting treated ceramic microspheres were characterized as described in Example 3, above. The angles of repose, and packing factor were 49.9 degrees and 41.1%, respectively.

Fluidization, Δh, was measured as described in Example 3, above. The fluidization value was 0.4.

### Examples 9 and 10 and Comparative Examples H and J

### Example 9

12.1 grams of colloidal silica nanoparticles (20 nm; 41.45% solids, obtained from Nalco Co., Naperville, Ill., under the trade designation “NALCO 2327”) were added to the 95 grams of nepheline syenite (obtained from Unimin Corporation, under the trade designation “MINEX 4”), and kneaded in a plastic bag for 5 minutes until completely blended, and dried in an oven at 100° C. for 3 hours.

The resulting treated nepheline syenite was characterized as described in Example 3, above. The angles of repose, and packing factor were 47.7 degrees and 42.3%, respectively.

Fluidization, Δh, was measured as described in Example 3, above. The fluidization value was 0.9.

This mixture can be added to a plurality of particles.

### Example 10

12.1 grams of colloidal silica nanoparticles (20 nm; 41.45%; “NALCO 2327”) were added to 95 grams of nepheline syenite (“MINEX 4”), and kneaded in a plastic bag for 5 minutes until completely blended, and dried in an oven at 100° C. for 3 hours to provide a first mixture. 40 grams of the first mixture was hand mixed with 160 grams of nepheline syenite (“MINEX 4”).

The resulting treated nepheline syenite was characterized as described in Example 3, above. The angles of repose, and packing factor were 48.8 degrees and 41.8%, respectively.

Fluidization, Δh, was measured as described in Example 3, above. The fluidization value was 0.5.

### Comparative Example H

200 grams of unmodified nepheline syenite (“MINEX 4”) were characterized as described in Example 3, above. The angles of repose, and packing factor were 46.7 degrees and 41.3%, respectively.

Fluidization, Δh, was measured as described in Example 3, above. The fluidization value was 0.4.

### Comparative Example J

4.8 grams of a colloidal silica nanoparticles (20 nm; 41.45%; “NALCO 2327”) were added to 200 grams of nepheline syenite (“MINEX 4”), and kneaded in a plastic bag for 5 minutes until completely blended, and then dried in an oven at 100° C. for 3 hours.

The resulting treated nepheline syenite was characterized as described in Example 3, above. The angles of repose, and packing factor were 47.7 degrees and 39.9%, respectively.

Fluidization, Δh, was measured as described in Example 3, above. The fluidization value was 0.4.

### Examples 11 and 12 and Comparative Examples K and L

### Comparative Example K

Comparative Example K was made by taking 180 grams of d-lactose (10 micrometers; obtained from Mallinkrodt Baker, Phillipsburg, N.J.), and grinding it for 5 minutes using a mortar and pestle. The resulting d-lactose was characterized as described in Example 3, above. The angle of repose was 41.2 degrees.

Fluidization, Δh, was measured as described in Example 3, above. The fluidization value was 0.8.

### Example 11

A surface modified nanoparticle dispersion (5 nm size, isooctyl/methyl surface modified) was prepared as described in Example 1, above. 20 grams of the surface modified nanoparticles were added to 180 grams of d-lactose (10 micrometers; obtained from Mallinkrodt Baker), and mixed until completely blended for 5 minutes using a mortar and pestle.

The resulting treated d-lactose was characterized as described in Example 3, above. The angle of repose was 35.4 degrees.

Fluidization, Δh, was measured as described in Example 3, above. The fluidization value was 2.0.

This mixture can be added to a plurality of particles.

### Example 12

Example 12 was prepared by combining 20 grams of Example 11, above, with 180 grams of d-lactose (10 micrometers; Mallinkrodt Baker), and grinding it in a mortar and pestle for 5 minutes.

The resulting treated d-lactose was characterized as described in Example 3, above. The angle of repose was 30.3 degrees.

Fluidization, Δh, was measured as described in Example 3, above. The fluidization value was 1.4.

### Comparative Example L

A surface modified nanoparticle dispersion (5 nm size, isooctyl/methyl surface modified) was prepared as described in Example 1, above. 2 grams of the surface modified nanoparticles were added to 198 grams of d-lactose (10 micrometers; Mallinkrodt Baker), and mixed until completely blended for 5 minutes using a mortar and pestle.

The resulting treated d-lactose was characterized as described in Example 3, above. The angle of repose was 30.3 degrees.

Fluidization, Δh, was measured as described in Example 3, above. The fluidization value was 1.4.

### Examples 13 and 14 and Comparative Examples M and N

### Comparative Example M

200 grams of calcium carbonate (CaCO₃, 10 micrometers; obtained from Sigma-Aldrich) was ground for 5 minutes using a mortar and pestle.

The resulting calcium carbonate was characterized as described in Example 3, above. The angle of repose was 48.8 degrees.

Fluidization, Δh, was measured as described in Example 3, above. The fluidization value was 0.9.

### Example 13

A surface modified nanoparticle dispersion (5 nm size, isooctyl/methyl surface modified) was prepared as described in Example 1, above. 20 grams of the surface modified nanoparticles were added to 180 grams of calcium carbonate (CaCO₃, 10 micrometers; Sigma-Aldrich), and mixed until completely blended for 5 minutes using a mortar and pestle.

The resulting treated calcium carbonate was characterized as described in Example 3, above. The angle of repose was 32.9 degrees.

Fluidization, Δh, was measured as described in Example 3, above. The fluidization value was 1.4.

This mixture can be added to a plurality of particles.

### Example 14

Example 14 was prepared by taking 20 grams of Example 13, above, combining it with 180 grams calcium carbonate (10 micrometers) and grinding it for 5 minutes in a mortar and pestle.

The resulting treated calcium carbonate was characterized as described in Example 3, above. The angle of repose was 34.7 degrees.

Fluidization, Δh, was measured as described in Example 3, above. The fluidization value was 1.0.

### Comparative Example N

A surface modified nanoparticle dispersion (5 nm size, isooctyl/methyl surface modified) was prepared as described in Example 1, above. 2 grams of the surface-modified nanoparticles were then added to 198 grams of calcium carbonate (CaCO₃, 10 micrometers; Sigma-Aldrich), and mixed until completely blended (5 minutes) using a mortar and pestle.

The resulting treated calcium carbonate was characterized as described in Example 3, above. The angle of repose was 34.1 degrees.

Fluidization, Δh, was measured as described in Example 3, above. The fluidization value was 1.2.

### Example 15 and Comparative Example O

### Comparative Example O

20 grams of d-lactose (10 micrometers; Mallinkrodt Baker) and 180 grams of calcium carbonate (CaCO₃, 10 micrometers; obtained from Sigma-Aldrich) were ground together for 5 minutes using a mortar and pestle.

The resulting d-lactose and calcium carbonate mixture was characterized as described in Example 3, above. The angle of repose was 42.9 degrees.

Fluidization, Δh, was measured as described in Example 3, above. The fluidization value was 0.9.

### Example 15

20 grams of treated d-lactose, prepared as described in Example 11, and 180 grams of calcium carbonate (CaCO₃, 10 micrometers; Sigma-Aldrich) were ground for 5 minutes using a mortar and pestle. The resulting ground d-lactose and calcium carbonate mixture was characterized as described in Example 3, above. The angle of repose was 34.7 degrees.

Fluidization, Δh, was measured as described in Example 3, above. The fluidization value was 1.4.

Various modifications and alterations of this invention will be apparent to those skilled in the art without departing from the scope and spirit of this invention, and it should be understood that this invention is not limited to the illustrative embodiments set forth herein.

1. A method of making a composition comprising a plurality of particles and nanoparticles the method comprising:
providing a first composition comprising a first plurality of particles and nanoparticles. wherein the nanoparticles are present in the first composition in an amount more than sufficient to at least one (a) improve at least one of the dispersibility, floodability, flowability, fluidization, packing factor, or tap density of the first composition relative, to the first composition free of nanoparticles or (b) decrease at least one of the bulk volume or entrained gas collectively of the first composition relative to the first composition free of nanoparticles; and
adding a second plurality of particles to the first composition to provide a second composition, wherein the nanoparticles are present in the second composition in an amount that is a least sufficient to at least one of (a) improve at least one of the dispersibility, floodability, flowability, fluidization, packing factor, or tap density collectively of the second composition relative to the collective second composition of particles free of nanoparticles or (b) decrease at least one of the bulk volume or entrained gas collectively of the second composition relative to the collective second composition free of nanoparticles.

2. The method of making a composition according to claim 1, wherein the nanoparticles include surface modified nanoparticles.

3. The method of making a composition according to claim 1, wherein the nanoparticles include non-surface modified nanoparticles.

4. The method of making a composition according to claim 1, wherein the particles of the first and second pluralities of particles are different.

5. The method of making a composition according to claim 1, wherein the particles of the first and second pluralities of particles are the same.

6. The method of making a composition according to claim 1, wherein the first plurality of particles include organic particles, and wherein the second plurality of particles include inorganic particles.

7. The method of making a composition according to claim 1, wherein the first plurality of particles includes inorganic particles, and wherein the second plurality of particles include organic particles.

8. The method of making a composition according to claim 1, wherein both the first and second pluralities of particles each independently include organic particles.

9. The method of making a composition according to claim 1, wherein both the first and second pluralities of particles each independently include inorganic particles.

10. The method of making a composition according to claim 1, wherein the particles of the first plurality of particles have a median particle size diameter less than 200 micrometers.

11. The method of making a composition according to claim 1, wherein the particles of both the first and second pluralities of particles each have a median particle size diameter less than 200 micrometers.

12. The method of making a composition according to claim 1, wherein the nanoparticles have average particle size diameter less than 100 nanometers.

13. The method of making a composition according to claim 1, wherein the nanoparticles have average particle size diameter less than 50 nanometers.

14. The method of making a composition according to claim 1, wherein the nanoparticles have average particle size diameter less than 10 nanometers.

15. The method according to claim 1, wherein the amount of nanoparticles in the first composition is in a range from 0.05 to 99 percent by weight, based on the total weight of the first composition.

16. The method according to claim 1, wherein the amount of nanoparticles in the first composition is in a range from 0.1 to 90 percent by weight, based on the total weight of the first composition.

17. The method according to claim 1, wherein the amount of nanoparticles in the second composition is in a range from 0.001 to 20 percent by weight, based on the total weight of the second composition.

18. The method according to claim 1, wherein the amount of nanoparticles in the second composition is in a range from 0.001 to 10 percent by weight, based on the total weight of the second composition.

19. The method according to claim 1, wherein the floodability of the second composition is improved by a least 5 percent relative to the second composition free of nanoparticles.

20. The method according to claim 1, wherein the nanoparticles include non-surface modified metal nanoparticles.
